(19) United States
(12) Patent Application Publication
(10) Pub. No.: US 2004/0198581 A1
(43) Pub. Date: Oct. 7, 2004

(54) Heavy-metal oxyfluoride glasses for high energy laser applications

(75) Inventor: Danh Tran, Potomac, MD (US)

Correspondence Address: BROWDY AND NEIMARK, P.L.L.C., 624 NINTH STREET, NW, SUITE 300, WASHINGTON, DC, 20001-5303, US

(73) Assignee: Infrared Fiber Systems, Inc., Silver Spring, MD

(21) Appl. No.: 10/814,193

(22) Filed: Apr. 1, 2004

Related U.S. Application Data
(60) Provisional application No. 60/459,358, filed on Apr. 2, 2003.

(51) Int. Cl. C03C 3/23; C03C 3/247

(52) U.S. Cl. 501/43; 501/44

(57) ABSTRACT

Maximizing the glass forming ability of low metal-phosphate content fluoride-based glasses allows the fabrication of large-size “crystal-free” HEL windows. This involves the addition of glass stabilizer oxides such as SiO₂, TiO₂, Al2O₃. In situ quenching is used to fabricate large-scale HEL windows substantially free of crystals, bubbles and striation.

This application is based on Provisional application 60/459,358, filed Apr. 2, 2003, the filing date of which is claimed, the contents of said application 60/459,358 being incorporated herein by reference.

### FIELD OF INVENTION

The present invention relates to heavy-metal oxyfluoride glass compositions for high energy laser applications, and windows made from such glasses, and more particularly to such glass compositions and windows having a thermal lensing coefficient (LC) which is zero or close to zero.

### BACKGROUND OF THE INVENTION

Recent advances in high-energy laser systems have made available power densities exceeding 10⁹ W/cm². Chemical-Oxygen-Iodine lasers (COIL) and HF lasers are being considered for use in the military. These high-power lasers have often induced thermal heating in the laser glass caused by residual stress from the optical pumping process and by absorbing trace impurities. This thermal effect results in beam quality degradation through distortion of the laser beam. The thermal lensing coefficient (LC) in a laser glass plays a critical role in the laser beam quality. LC is defined as:

LC=(n−1) (1+pr)CTE+dn/dT (1)

where,

n=refractive index

pr=Poisson's ratio

CTE=coefficient of thermal expansion

dn/dT=temperature dependence of refractive index

Depending on the lens coefficient of the glass, when a laser beam passes through an optical window, it will behave as follows (see FIG. 1):

(a) If the LC is positive, the beam will converge and optical focusing takes place;

(b) If the LC is negative, the beam will diverge leading to optical defocusing;

(c) If the LC is zero, the beam will have zero optical pass distortion (zero OPD). This is called “optical flat”.

Clearly, an ideal High Energy Laser (HEL) window should have zero or near zero OPD. There are five main criteria in an ideal HEL optical material: first, to achieve zero OPD, dn/dT must be negative since the first term of equation (1) is always positive. An optical glass with negative dn/dT is referred to as “athermal”; second, the glass composition must be tailored as to obtain n, pr, and CTE values which, when combined, cause the first term to cancel out the second term of equation (1); third, the material should possess high thermal stability to enable the fabrication of large size glass articles without inducing crystallization; fourth, the material should exhibit high transmission from the UV to the mid-infrared wavelength region (0.28 to 2.8 μm). The operational wavelengths for the COIL and HF lasers are 1.3 μm and 1.06 μm, respectively; and fifth, the material must be corrosion resistant.

Optical materials having negative dn/dT are not common. A few existing athermal materials include: fluorine-containing glasses, such as zirconium-based fluoride glasses or aluminum-based fluoride glasses, calcium fluoride crystal, and oxide-containing materials such as phosphate glasses. Athermal glasses that have been considered for HEL include ZrF₄-based glass, AlF₃-based glass and metal-phosphate-containing fluoride glass.

The most common type of fluoride-based glasses is ZBLAN, which stands for ZrF₄—BaF₂—LaF₃—AlF₃—NaF (Ohsawa et al U.S. Pat. No. 4,445,755). This glass is highly transparent from the UV out to 5 μm microns, has a negative dn/dT of around −13.45E-6/° C., but is susceptible to water attack and has insufficient mechanical strength. Furthermore, the glass stability in ZBLAN is only marginal; and, as a result, crystal formation often occurs when processing large-scale glass articles. For these reasons, ZBLAN does not meet the needs for quality HEL window applications.

Another type of fluoride glass is AlF₃-based; as for example AlF₃—RF₂—NaF—ZrF₄, where R represents Mg, Ca, Sr, and Ba (Tokida et al U.S. Pat. No. 4,761,387). This glass transmits as well as ZBLAN, i.e. from the UV to about 5 μm, has a negative dn/dT of −8.19E-6/° C., a relatively good chemical durability, but a high tendency toward crystallization. As with ZBLAN, these glasses are not suitable for HEL applications.

Commercially available CaF₂ crystal also is athermal with dn/dT=−10.6E-6/° C.; but this crystalline material cannot be scaled to large size because the temperature gradient in the crystal growing process gives rise to thermal distortion in the bulk material. Most important of all, despite having a negative thermal change of refractive index, no materials have been found to possess near zero LC. For example, using the n, pr, CTE and dn/dT for the above materials, the LC of each can be obtained:

TABLE 1
Values of Lens Coefficient Obtained for Existing
Athermal Optical Materials

| | | | | dn/dT | LC |
|---|---|---|---|---|---|
| Material | n | pr | CTE (ppm/° C.) | (ppm/C) | ppm/° C.) |
| ZBLAN | 1.5000 | 0.28 | 17.5 | −13.45 | −2.25 |
| AlF₃-based | 1.4404 | 0.28 | 16.1 | −8.19 | +0.88 |
| CaF₂ | 1.3990 | 0.26 | 18.85 | −10.6 | −1.12 |

It can be expected that ZBLAN and CaF₂ will defocus the high power laser beam and AlF₃-based glasses will focus it.

Metal-phosphate containing fluoride glass such as (in mol %) (1-25) AlF₃— (20-65) RF₂— (1-20)MF— (0.1-20)M′ₓ(PO₃)_{y}, where M′ represents Al, Ba, Mg, Na and K, does meet the optical, mechanical and chemical criteria for HEL windows, similar to the AlF₃-based glass described above. Moreover, the stability of the metal-phosphate containing fluoride glass is greatly enhanced provided the concentration of metal-phosphate, M′ₓ(PO₃)_{y}, is sufficiently high (i.e. much greater than 12 mol. %).

The critical cooling rate, Rc, for this type of fluoride glass with high metal-phosphate content was determined to be as low as 4.5° C./min. Rc is defined as the cooling rate below which crystal will be formed; thus the lower the Rc, the higher the glass forming ability, i.e. a low Rc is desirable. Unlike other glasses which do not permit the manufacture of “crystal-free” HEL windows larger than 3 inches in diameter and about one-half inch in thickness, the high thermal stability of these fluoride glasses with high metal-phosphate content has enabled us to fabricate large-scale “crystal-free” HEL windows. One drawback, however, is that the large concentration of metal-phosphate induces a strong absorption band at around 4.8 μm due to P—O vibration, and a smaller and broader absorption band at around 3 μm due to hydroxyls OH which are generally bonded to the phosphate radical.

Similar to fluorides, some metal phosphates exhibit low polarizability and high thermal expansion and do have negative dn/dT (Myers et al U.S. Pat. No. 5,322,820); however to date, none of these glasses possess the right combination of n, pr, CTE and dn/dT leading toward zero LC.

As indicated above, some fluoride, oxyfluoride and fluoro-phosphate glasses are known, noting for example the U.S. Pat. Nos. of Tran 5,809,199; 5,160,521; 5,045,507; and 5,274,728; and Tran et al 5,055,120.

### SUMMARY OF THE INVENTION

At the present time, among all known athermal materials, there is none with near zero LC. The present invention relates to glass compositions having:

(1) high optical transmission from the UV to about 3.5 μm;

(2) high chemical durability;

(3) excellent thermal stability; and

(4) specific values of n, pr, CTE and dn/dT such that the LC of equation (1) becomes zero or near zero.

The present invention relates to glass compositions called oxyfluoride glasses which include both fluorides and oxides and which have the proper n, pr, CTE and dn/dT characteristics to yield a near zero LC. The invention also involves glass compositions with near zero OPD which exhibit high thermal stability and high transmission from 0.28 μm to 2.8 μm, HEL windows, especially large windows, made therefrom, and HEL fibers and rods.

### BRIEF DESCRIPTION OF THE DRAWING

FIG. 1 is schematic illustration showing the necessary prerequisites for high-energy laser windows.

FIG. 2 is a graph showing near infrared transmission of oxyfluoride glass 2 mm thick according to the present invention.

FIG. 3 is a graph showing the visible transmission of oxyfluoride glass 2 mm thick in accordance with the present invention.

### DETAILED DESCRIPTION OF EMBODIMENTS

The glass compositions of the present invention include a mixture of AlF₃, RF₂ (where R is selected from the alkaline-earth metals Mg, Ca, Sr, and Ba, preferably all four), R′F (where R′ represents the alkali metals Li, Na, K, and Cs), and M(PO₃)ₓ (where M is selected from the group consisting of Ba, Mg, Na, Ta, Li, Al, and K), and an oxide glass stabilizer desirably of the formula M_{y}′O (where M′ is selected from the group Zr, Ti, Ge, Al, Ga, Hf, Ta and Si), and optionally a fluoride glass stabilizer of at least one of HfF₄, ZrF₄ and GaF₃. In this invention, the concentrations (in mol %) of the glass components preferably are as follows: 1-25 AlF₃, more preferably 1-20%; 20-65 RF₂; 1-20 R′F; 0.1-12 M(PO₃)ₓ; and 0.1-12 M′_{y}O_{z}, more preferably 0.2-8%, most preferably 0.5-6%. If an optional fluoride glass stabilizer is incorporated to replace a portion of the oxide glass stabilizer, such fluoride glass stabilizer should be present in an amount no greater than 80% based on 100% glass stabilizer, and preferably no greater than 45% based on 100% glass stabilizer.

Metal phosphate M(PO₃)ₓ is generally known as an excellent glass former. Oxyfluoride glasses containing large amount of M(PO₃)ₓ exceeding 12 mol % have excellent glass forming ability. Their critical cooling rate Rc, defined as the slowest cooling rate a melt can sustain without inducing crystallization, is as low as 4.5° C. per min. These glasses can be fabricated into large scale window measuring up to 0.5 m in diameter and several inches thick without being crystallized. Large concentration of M(PO₃)ₓ however gives rise to strong absorption around 4.8 μm due to P—O vibration and around 3 μm due to hydroxyls OH which have strong affinity for the phosphate radical. To minimize these absorptions, the M(PO₃)ₓ content must be reduced to less than or equal to 12 mol percent, preferably to no greater than 8 mol %, at the expense of the glass forming ability.

One object of the invention is to utilize selected metal oxides and/or metal fluorides stabilizers to enhance the glass stability despite the low metal phosphate concentration. These stabilizers must be selected among metal oxides or fluorides which exhibit high bonding energy. The essence of the relation between bond strength and glass formation is the assumption that the stronger-bonded components in a glass melt are less likely to have their bond ruptured. When bond rupture occurs, the glass melt is subject to structural reordering which is considered to be the initial stage of crystallization. Silica and phosphate which are among the most stable compounds. In these embodiments, the selected glass stabilizers are listed in Table 2.

TABLE 2
Selected glass stabilizers

| Stabilizers | Bond Energy (kcal/mol) |
|---|---|
| SiO₂ | 190.9 |
| GeO₂ | 158.2 |
| Ga₂O₃ | 68 |
| HfO₂ | 189.8 |
| ZrO₂ | 181.6 |
| TiO₂ | 158.2 |
| Al₂O₃ | 122 |
| Ta₂O₃ | 194.5 |
| HfF₄ | 157 |
| ZrF₄ | 149 |
| GaF₃ | 138 |

Zero Lensing Coefficient: One of the prerequisites for zero LC is a negative thermal change of refractive index dn/dT. The dn/dT is given by the following equation:

$$ⅆ n / ⅆ T = \frac{( {n}^{2} - 1 ) ( {n}^{2} + 2 )}{6 n} ( Φ - 3 CTE ) \qquad ( 2 )$$

where Φ is polarization coefficient of the material. According to equation (2), the search for compositions of athermal materials must aim at high thermal expansion and low change in polarizability. The relation between polarization and bond strength is given by:

Φ=(Z/a²−rₖ) (3)

where,

Z: charge of cation

a: distance between cation and anion

rₖ: radius of cation

From equations (2) and (3), it is evident that fluoride-based glasses are the best candidate for athermal behavior since the bond strength decreases by a factor of two when 0-2 is replaced by F⁻ coupled with a large increase in thermal expansion.

The present invention relates to athermal oxyfluoride glass compositions comprising mostly AlF₃ and alkaline-earth metal fluorides RF₂ such as MgF₂ , CaF₂ , SrF₂ and/or BaF₂, preferably all four together, and smaller amounts of alkali-metal fluorides R′F such as NaF, LiF, KF and/or CsF, as well as metal phosphates M(PO₃)ₓ such as Ba(PO₃)₂, Mg(PO₃)₂, NaPO₃, LiPO₃, KPO₃, and/or Al(PO₃)₃ in limited amounts. The thermal stability of these glasses are optimized by incorporating silica and/or metal oxide glass stabilizers M′_{y}Oₓ optionally with metal fluoride glass stabilizers M″Fₓ having high bond energy; and the amount of each component in the glass has been tailored as to give a range of values for n, pr, CTE and dn/dT which results in a near zero lens coefficient.

The preferred range of oxyfluoride glass compositions is as follows:

TABLE 3
Range of oxyfluoride glass compositions

| | Concentration |
|---|---|
| Components | (mol %) |
| Ba(PO₃)₂, Mg(PO₃)₂, NaPO₃, LiPO₃, | 0.1-12 |
| KPO₃ or Al (PO₃)₃ | |
| MgF₂ | 3-10 |
| CaF₂ | 10-20 |
| SrF₂ | 15-30 |
| BaF₂ | 10-20 |
| AlF₃ | 10-25 |
| LiF, NaF, and/or KF | 1-15 |
| Ga₂O₃, GeO₂, SiO₂, TiO₂, Al₂O₃, HfO₂, Ta₂O₃ and/or | 0.1-12, |
| ZrO₂, optionally with HfF₄, GaF₃ and/or ZrF₄ | preferably |
| | 0.2-8, more |
| | preferably |
| | 0.5-6 |

Oxyfluoride glass articles disclosed in the present invention can be made by casting or pouring the melt from a platinum melt crucible into a metallic mold, preferably made from brass, pre-heated to the glass transition temperature, and letting the melt cool slowly to room temperature. Another method of transferring the melt to a mold is to use a platinum crucible equipped with a bottom nozzle through which the molten glass is drained into the mold.

The most preferred method is the in-situ quenching technique described in Tran U.S. Pat. No. 5,045,507. In this method, the molten glass is quenched until it solidifies inside the platinum melt crucible itself, without pouring or draining. The advantages of using this latter technique includes: (1) avoiding contamination caused by the melt being in contact with the mold whereby the glass can be re-melted if necessary without the glass becoming contaminated; (2) avoiding bubble formation due to turbulent flow when pouring or draining; and (3) avoiding using excess melt, because in the casting and draining methods approximately one-third of the melt at the top and/or at the bottom of the melt crucible must be discarded.

The glasses of the present invention can be cooled more quickly without inducing striations and crystallization. Whereas the best cooling rate possible in the prior art, i.e. for metal phosphate glasses, was 4.5° C. per minute, the present glasses can be cooled as slowly as 4.0° C./min, and indeed even more slowly, e.g., 2.5° C./min and sometimes even slower, a desirable feature. Thus, the critical cooling rates, Rc, for the oxyfluoride glass of the present invention is 4.0° C./min, and even lower, e g. 2.5° C./min.

Contrary to the prior art, good quality “crystal-free” HEL windows of large size can be formed from the present oxyfluoride lasses, e.g. windows greater than 3 inches in diameter and preferably greater than 4 inches diameter, and having thicknesses greater than one-half inch of course, good quality smaller windows can also be formed from these glasses. The windows of the present invention are substantially free of crystals, have low absorbability at the operational wavelengths, have good chemical durability and thermal stability, are substantially free of striations and index inhomogeneity, and provide minimal wavelength distortion of laser beams transmitted therethrough.

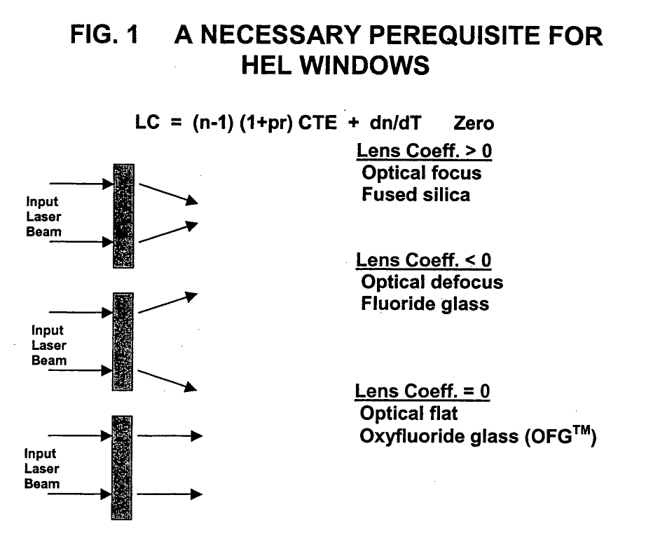

In addition, to the formation of HEL windows of large and small size, the oxyfluoride glass of the present invention can be made into active laser components such as laser rods and fibers by incorporation of up to 8 mol % of rare-earth metals, e.g. Nd, Yb, Ho, Er, Tm and Dy. Laser rods made from previous laser glass do not have near zero lensing coefficient and therefore either will focus or defocus the beam during active lasing, e.g. compare FIG. 1 which shows the phenomena for laser windows. Thus, complicated and expensive lens systems have been needed to be coupled to such prior laser rods to redirect the laser beam. Laser rods made from heavy-metal oxyfluoride glass according to the present invention, into which one or more rare-earth metals are incorporated, generate a sharp laser beam with no distortion, thereby avoiding the necessity of using such complicated and expensive lens systems.

The present invention will be further described below by way of non-limiting examples.

### EXAMPLE 1

120 g of an oxyfluoride glass containing 5.5 mol % Al(PO₃)₃, 53.5 mol % RF₂, 20.0 mol % AlF₃, 16 mol % R′F, 3.0 mol % Al₂O₃, and 2.0 mol % SiO₂ were batched in a platinum crucible, 1.5 in. diam. by 3 in. high, inside a nitrogen atmosphere glove box. The crucible was transferred into an electrically heated furnace also placed inside the box and the mixed powder was melted at 975° C. for 2 hrs. The molten glass was then cooled to room temperature at a rate of 4.5° C./min. The stability of the glass was characterized by identifying crystal formation using a high magnification Zeiss polarized light microscope capable of identifying crystals as small as 2 μm in size. Examination of the glass showed no crystalline defects or striations. The values of n, pr, CTE and dn/dT of the glass were measured at 1.3 μm and are given below:

n 1.4650

pr 0.31

CTE 14.69 ppm/° C.

dn/dT −8.944 ppm/° C.

Using the lens coefficient equation (1), the LC value of the glass was determined to be almost zero, namely 0.004 ppm/° C. or 0.004×10⁻⁶/° C.

### EXAMPLE 2

120 g of the same glass as in Example 1 was melted in a similar fashion as described in Example 1. The molten glass was then quenched to room temperature at a rate of 2.5° C./min. Close examination of the glass using a high magnification Zeiss polarized light microscope, capable of identifying crystals as small as 2 μm in size, revealed no crystals or striations.

### EXAMPLE 3

120 g of an oxyfluoride glass containing 5.5 mol % Al(PO₃)₃, 53.5 mol % RF₂, 20.0 AlF₃, 15.3 mol % R′F, 1.70 mol % Al₂O₃, and 4.0 mol % SiO₂ were batched in a platinum crucible, 1.5 in. diam. by 3 in. high, inside a nitrogen atmosphere glove box. The crucible was transferred into an electrically heated furnace also placed inside the box and the mixed powder was melted at 975° C. for 2 hrs. The molten glass was then cooled to room temperature at a rate of 1.1° C./min. The stability of the glass was characterized by identifying crystal formation using a high magnification Zeiss polarized light microscope capable of identifying crystals as small as 2 μm in size. Examination of the glass showed no crystalline defects or striations. The values of n, pr, CTE and dn/dT of the glass were measured at 1.3 μm and are given below:

n 1.4647

pr 0.31

CTE 14.66 ppm/° C.

dn/dT −8.903 ppm/° C.

Using the lens coefficient equation (1), the LC value of the glass was determined to be almost zero, namely 0.021 ppm/° C. or 0.021×10⁻⁶/° C.

### EXAMPLE 4

120 g of an oxyfluoride glass containing 5.5 mol % Al(PO₃)3, 1.92 mol % Al₂O₃, 20.0 AlF₃, 16.0 mol % R′F, 54.58 mol % RF₂, and 2.0 mol % GeO₂ were batched in a platinum crucible, 1.5 in. diam. by 3 in. high, inside a nitrogen atmosphere glove box. The crucible was transferred into an electrically heated furnace also placed inside the box and the mixed powder was melted at 975° C. for 2.5 hrs. The molten glass was then was then cooled to room temperature at a rate of 2.5° C./min. The stability of the glass was characterized by identifying crystal formation using a high magnification Zeiss polarized light microscope capable of identifying crystals as small as 2 μm in size. Examination of the glass showed no crystalline defects or striations. The values of n, pr, CTE and dn/dT of the glass were measured at 1.3 μm and are given below.

n 1.4662

pr 0.31

CTE 14.8 ppm/° C.

dn/dT −9.002 ppm/° C.

A near zero LC of 0.036×10⁻⁶/° C. was obtained from equation (1).

### EXAMPLE 5

100 g of an oxyfluoride glass containing 5.5 mol % Al(PO₃)₃, 1.92 mol % Al₂O₃, 20.0 AlF₃, 16.0 mol % R′F, 54.58 mol % RF₂, and 2.0 mol % Ga₂O₃ were batched in a platinum crucible, 1.5 in. diam. by 3 in. high, inside a nitrogen atmosphere glove box. The crucible was transferred into an electrically heated furnace also placed inside the box and the mixed powder was melted at 975° C. for two hours. The molten glass was then was then cooled to room temperature at a rate of 2.5° C./min. The stability of the glass was characterized by identifying crystal formation using a high magnification Zeiss polarized light microscope capable of identifying crystals as small as 2 μm in size. Examination of the glass showed no crystalline defects or striations. The values of n, pr, CTE and dn/dT of the glass were measured at 1.3 μm and are given below:

n 1.4656

pr 0.31

CTE 14.60 ppm/° C.

dn/dT −8.840 ppm/° C.

A near zero LC of 0.065×10⁻⁶/° C. was obtained from equation (1).

### EXAMPLE 6

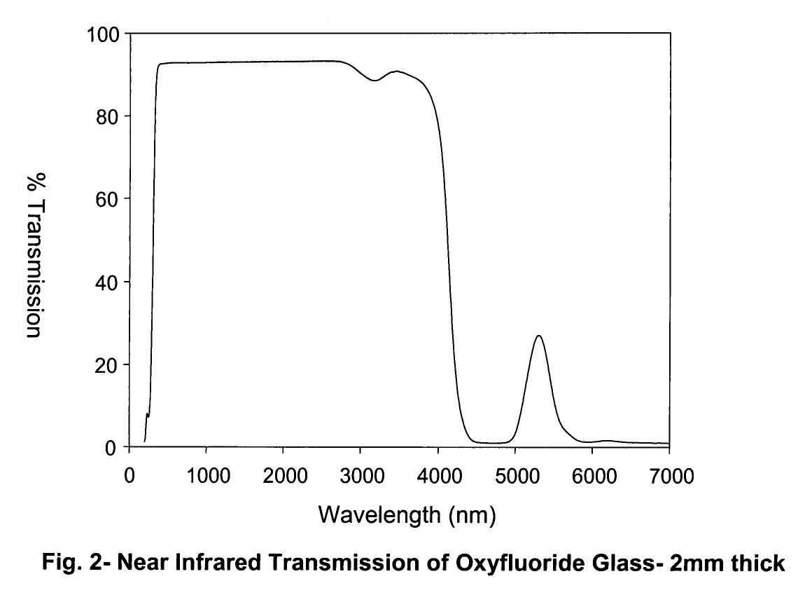

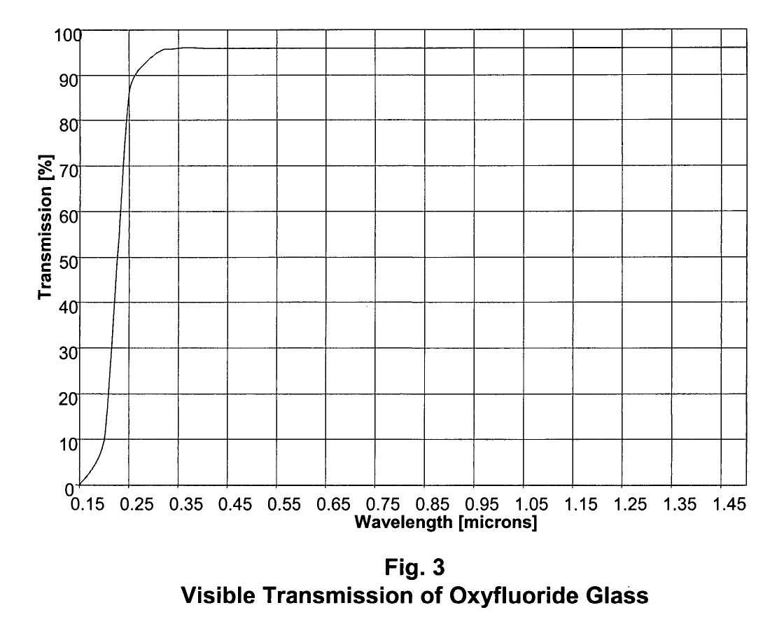

The transmission curves for glass windows 2 mm thick formed of glasses of Examples 1,3 and 5 obtained in the Visible and Near Infrared are plotted in FIG. 2 and FIG. 3, respectively. The transmission which includes Fresnel losses of about 7% on both surfaces of the glass sample indicates these glasses are highly transparent from 0.28 μm to 2.8 μm.

### EXAMPLE 7

The chemical resistance of glasses of Examples 1 through 6 was investigated, using standard chemical durability test method, by exposing the glasses to a slightly basic solution which simulated seawater. The buffer solution consisted of mixing 10 ml of 0.2M NaCl, 3 ml 0.3M NaHCO₃, and 0.5 to 1 ml of 0.01M NH₄OH, then diluting the mixture to 50 ml H₂O as to give the solution a pH of around 8.2. The glass samples were immersed in the buffer solution for 100 hrs as part of the stain resistant test. At the end of 100 hr-immersion, no staining was observed on the glass surface.

### EXAMPLE 8

A 28 kg batch of the same glass as in Example 1 was charged into a platinum crucible measuring 16.5 in. diameter by 6 in. tall by 0.070 in. wall thickness. The crucible was fitted with a platinum cap and a platinum stirrer. A hole of 0.5 in. was opened at the center of the cap to accommodate the stirring shaft. The melt assembly was placed inside an electrically heated furnace. The melting process was carried out at 1000° C. for 2 hrs and refined at 900° C. for 8 hrs under nitrogen atmosphere. The stirrer was set at 15 rpm. After refining the furnace was turned off and the molten glass was in-situ cooled inside the crucible at a rate of 3.5° C. per min. After solidification, the window was annealed at 380° C. for 2 hrs. and slowly cooled down to room temperature. The final window measured 16.5 in. diam. by 2.1 in. thick. It had no crystalline and bubble defects, and no striations.

### EXAMPLE 9

A 75 kg batch of the same glass as in Example 5 was charged in a high-density graphite crucible measuring 39.37 in. diameter by 8 in. tall by 1.5 in. wall thickness. The crucible was fitted with a graphite cap and a platinum stirrer. A hole of 0.5 in. was opened at the center of the cap to accommodate the stirring shaft. The melt assembly was placed inside an electrically heated furnace. Melting was carried out at 1000° C. for 6 hrs followed by refining at 900° C. for 15 hrs under a nitrogen atmosphere. The stirrer was set at 25 rpm. After refining the furnace was turned off and the molten glass was in-situ cooled inside the crucible at a rate of 1.5° C. per min. After solidification, the window was annealed at 380° C. for 6 hrs. and slowly cooled down to room temperature. The final window measured 39.37 in. diam. by 1.0 in. thick. It had no crystalline and bubble defects, and no striations.

Set forth below in Table 4 are some specific examples of glass compositions in accordance with the present invention:

TABLE 4
mol % of Components

| | Example | | | | |
|---|---|---|---|---|---|
| | 10 | 11 | 12 | 13 | 14 |
| Ba (PO₃)₂ | — | 4.0 | — | — | — |
| Mg (PO₃)₂ | — | — | 6.2 | — | — |
| NaPO₃ | — | — | — | 7.5 | — |
| LiPO₃ | 0.2 | — | — | — | — |
| KPO₃ | — | — | — | — | 9.0 |
| Al (PO₃)₂ | 3.0 | — | — | — | — |
| MgF₂ | 4.0 | 3.5 | 8.0 | 10.0 | 3.0 |
| CaF₂ | 10.0 | 4.0 | 10.0 | 18.0 | 16.8 |
| SrF₂ | 20.0 | 26.0 | 25.0 | 18.0 | 23.0 |
| BaF₂ | 17.8 | 20.0 | 13.0 | 10.0 | 15.0 |
| AlF₃ | 25.0 | 23.0 | 15.0 | 16.0 | 14.0 |
| LiF | 15.0 | 1.0 | — | 1.5 | — |
| NaF | — | 5.2 | 14.0 | 12.5 | 18.0 |
| KF | — | 4.3 | 5.0 | 2.5 | — |
| Ga₂O₃ | 5.0 | — | — | — | — |
| GeO₂ | — | 5.0 | — | — | 1.0 |
| SiO₂ | — | — | 2.2 | — | 0.2 |
| TiO₂ | — | — | 1.2 | — | — |
| Al₂O₃ | — | 3.2 | — | — | — |
| HfO₂ | — | — | — | 3.3 | — |
| Ta₂O₃ | — | — | — | 0.5 | — |
| ZrO₂ | — | — | — | 0.2 | — |
| HfF₄ | — | 0.8 | — | — | — |
| GaF₃ | — | — | 0.2 | — | — |
| ZrF₄ | — | — | 0.2 | — | — |

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

The means, materials, and steps for carrying out various disclosed functions may take a variety of alternative forms without departing from the invention. Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A heavy-metal oxyfluoride glass adapted for high energy laser applications, consisting essentially of
(i) 1-25 mol % AlF₃,
(ii) 20-65 mol % in total of RF₂,
(iii) 1-20 mol % in total of R′F,
(iv) 0.1-12 mol % in total of M(PO₃)ₓ,
(v) 0.1-12 mol % in total of at least one oxide of ZrO₂, TiO₂, GeO₂, Al₂O₃, Ga₂O₃, SiO₂, Ta₂O₃ and HfO₂, wherein part of said 0.1-5% oxide is optionally replaceable by at least one of HfF₄, GaF₃ and ZrF₄, and
and incidental or unavoidable impurities in amounts insufficient to adversely affect the basic character of said glass,
wherein R is at least one of Mg, Ca, Sr, and Ba; R′ is at least one of Li, Na, K and Cs; M is at least one of Ba, Mg, Na, Li, Al and K; x is 3 for M of valence 3, x is 2 for M of valence 2, and x is 1 for M of valence 1;
said heavy-metal oxyfluoride glass being capable of being quenched from a molten state to room temperature at a rate of 4.0° C./min without apparent crystallization.

2. The heavy-metal oxyfluoride glass of claim 1 wherein said oxide, optionally replaced in part by at least one of HfF₄, ZrF₄ and GaF₃, is present in an amount of at least 0.2 mol %.

3. The heavy-metal oxyfluoride glass of claim 1 wherein said oxide, optionally replaced in part by at least one of HfF₄, ZrF₄ and GaF₃, is present in an amount of at least 0.5 mol %.

4. The heavy-metal oxyfluoride glass of claim 1 wherein said oxide, optionally replaced in part by at least one of HfF₄, ZrF₄ and GaF₃, is present in an amount no greater than 8 mol %.

5. The heavy-metal oxyfluoride glass of claim 1 wherein said oxide, optionally replaced in part by at least one of HfF₄, ZrF₄ and GaF₃, is present in an amount of no greater than 6 mol %.

6. The heavy metal oxyfluoride glass of claim 1 wherein at least one of said HfF₄ and ZrF₄ is present in an amount up to no greater than 80 mol % of said component (v).

7. The heavy metal oxyfluoride glass of claim 1 wherein at least one of said HfF₄ and ZrF₄ is present in an amount up to no greater than 45 mol % of said component (v).

8. The heavy metal oxyfluoride glass of claim 1 wherein said component (iv) is present in an amount no greater than 8 mol %.

9. The heavy metal oxyfluoride glass of claim 1 wherein said AlF₃ is present in an amount of 10-25 mol %, said component (ii) comprises 3-10 mol % MgF₂, 10-20 mol % CaF₂, 15-30 mol % SrF₂ and 10-20 mol % BaF₂, and component (iii) is present in an amount of 1-15 mol %.

10. The heavy metal oxyfluoride glass of claim 1, wherein component (ii) comprises a mixture of MgF₂, CaF₂, SrF₂, and BaF₂.

11. The heavy metal oxyfluoride glass of claim 1, wherein said heavy metal oxyfluoride glass is capable of being quenched from a molten state to room temperature at a rate of 2.5° C./min without apparent crystallization.

12. A window formed of the glass of claim 1, said window being substantially free of crystals, having low absorption at the operational wavelengths, having good chemical durability and thermal stability, being substantially free of striations and index inhomogeneity, and providing minimal wavefront distortion of a laser beam being transmitted through said window.

13. A window formed of the glass of claim 2, said window being substantially free of crystals, having low absorption at the operational wavelengths, having good chemical durability and thermal stability, being substantially free of striations and index inhomogeneity, and providing minimal wavefront distortion of a laser beam being transmitted through said window.

14. A window formed of the glass of claim 3, said window being substantially free of crystals, having low absorption at the operational wavelengths, having good chemical durability and thermal stability, being substantially free of striations and index inhomogeneity, and providing minimal wavefront distortion of a laser beam being transmitted through said window.

15. A window formed of the glass of claim 4, said window being substantially free of crystals, having low absorption at the operational wavelengths, having good chemical durability and thermal stability, being substantially free of striations and index inhomogeneity, and providing minimal wavefront distortion of a laser beam being transmitted through said window.

16. A window formed of the glass of claim 5, said window being substantially free of crystals, having low absorption at the operational wavelengths, having good chemical durability and thermal stability, being substantially free of striations and index inhomogeneity, and providing minimal wavefront distortion of a laser beam being transmitted through said window.

17. A window formed of the glass of claim 6, said window being substantially free of crystals, having low absorption at the operational wavelengths, having good chemical durability and thermal stability, being substantially free of striations and index inhomogeneity, and providing minimal wavefront distortion of a laser beam being transmitted through said window.

18. A window formed of the glass of claim 7, said window being substantially free of crystals, having low absorption at the operational wavelengths, having good chemical durability and thermal stability, being substantially free of striations and index inhomogeneity, and providing minimal wavefront distortion of a laser beam being transmitted through said window.

19. A window formed of the glass of claim 8, said window being substantially free of crystals, having low absorption at the operational wavelengths, having good chemical durability and thermal stability, being substantially free of striations and index inhomogeneity, and providing minimal wavefront distortion of a laser beam being transmitted through said window.

20. A window formed of the glass of claim 9, said window being substantially free of crystals, having low absorption at the operational wavelengths, having good chemical durability and thermal stability, being substantially free of striations and index inhomogeneity, and providing minimal wavefront distortion of a laser beam being transmitted through said window.

21. The window of claim 12 having a size greater than 3 inches in diameter and/or one-half inch in thickness.

22. The window of claim 21 having a diameter greater than four inches.

23. A window formed of the glass of claim 10, said window being substantially free of crystals, having low absorption at the operational wavelengths, having good chemical durability and thermal stability, being substantially free of striations and index inhomogeneity, and providing minimal wavefront distortion of a laser beam being transmitted through said window.

24. A window formed of the glass of claim 11, said window being substantially free of crystals, having low absorption at the operational wavelengths, having good chemical durability and thermal stability, being substantially free of striations and index inhomogeneity, and providing minimal wavefront distortion of a laser beam being transmitted through said window.

25. The heavy-metal oxyfluoride glass of claim 1 further comprising a rare-earth metal, wherein said rare-earth metal is present in an amount of up to 8 mol % of said oxy-fluoride glass.

26. A laser-transmittable rod or fiber formed of the glass of claim 25.
